(19) United States
(12) Patent Application Publication
(10) Pub. No.: US 2015/0017380 A1
(43) Pub. Date: Jan. 15, 2015

(54) ABSORBENT FOOD PAD HAVING DISCRETE AIRFLOW PASSAGES

(71) Applicant: Paper-Pak Industries, Laverne, CA (US)

(72) Inventors: Sayandro Versteylen, Fontana, CA (US); Richard Beu, Yorba Linda, CA (US); Brett N. Stoll, Rancho Cucamonga, CA (US)

(21) Appl. No.: 14/325,673

(22) Filed: Jul. 8, 2014

Related U.S. Application Data
(60) Provisional application No. 61/844,354, filed on Jul. 9, 2013.

(51) Int. Cl. B65D 81/26; B32B 3/26; A23B 7/152

(52) U.S. Cl. CPC B65D 81/264; A23B 7/152; B32B 3/266; A23V 2002/00; B32B 2250/03; B32B 2307/726; B32B 2307/724; B32B 2439/70
USPC 428/76

(57) ABSTRACT

An absorbent food pad having one or more apertures that provide discrete airflow passages through the absorbent food pad is provided. The apertures permit the absorbent food pads to be placed below a food product in a container without blocking the flow of air through the container. The absorbent food pad contains an active system, such as an SO₂ generation system, or any other system that enhances freshness and prolongs the shelf life of fruits, vegetables, and other food products during transport and storage to prevent and/or minimize disease.

### RELATED APPLICATION

This application claims priority to U.S. provisional application Ser. No. 61/844,354 filed on Jul. 9, 2013, which is incorporated herein by reference.

### BACKGROUND OF THE DISCLOSURE

1. Field of the Disclosure

The present disclosure provides an absorbent food pad having discrete airflow passages through the absorbent food pad. The absorbent food pad enhances freshness and prolongs the shelf life of fruits, vegetables, and other food products, that are packaged in crates during transport and storage.

2. Description of Related Art

Botrytis cinerea is a fungus that affects many plant species, particularly fruits such as grapes and berries. When fruits and berries are hand-picked or handled by machinery, they are susceptible to mechanical damage, such as splits or cuts or abrasion. Damage can also be caused by insects and even wind. The damaged areas of the grapes or berries can serve as entry sites for microorganisms, such as B. cinerea.

In grapes, for example, infection with botrytis is called gray mold, and causes rapid deterioration of grapes, formation of a moldy growth, or in some instances, loss of the entire crop by botrytis bunch rot. This can destroy the marketability and desirable qualities of the grapes. Berries that are infected with botrytis are not edible and are generally discarded. Botrytis also can cause damage to tomatoes, figs and other fruits.

Conventionally, large-scale storage and preservation of grapes after picking has been by placing the grapes in open containers in enclosed rooms, and generating sulfur dioxide (SO₂) gas into the enclosed room to pass into the containers and among the grapes. If the grapes are placed in a cold storage room, such bulk treatment with SO₂ gas, if periodically repeated, is somewhat effective in preserving the grapes from deterioration caused by botrytis and other microorganisms. However, as soon as the treatment is completed, the gas begins dissipating, and there is often is no continuity of treatment.

Another method used is a pad of kraft paper, extruded kraft paper with polyethylene, and polypropylene, with the active component sodium metabisulfite (Na₂S₂O₅) that generates SO₂ gas upon contact with humidity. Covering the paper with plastic polymers prevents direct contact of grapes or berries with the active component.

However, these pads are wrapped on the tops of the pallets containing the crates of grapes. The pads are made of kraft paper, which does not absorb any liquid at all. Such pads cannot be placed on the bottom of an individual crate.

Also, when grapes are shipped, the containers are generally air cooled from the bottom. The paper pads cannot be placed on the bottom of an individual crate because it would impede (cool) air flow. Hence, these pads are placed on the top of the crates.

However, placement of the pads on top of the crates causes another problem. As the grapes are cooled, condensation forms inside the bag that is placed over the pallet to retain the SO₂. This condensation can cause the sulfur-containing active Na₂S₂O₅ to drip onto the fruit, causing chemical burns that are called “sulfur burn” or “grape burn” and damage the fruit.

### SUMMARY OF THE DISCLOSURE

The present disclosure provides an absorbent food pad that has one or more apertures that are discrete airflow passages through the absorbent food pad.

The apertures (also called “holes” or “spaces” in this application with no change in meaning) typically represent about 10% to about 68% of the geometric area of the top surface of the substrate; or when considered as a ratio of space-to-substrate of the absorbent food pad, from about 1:9 to about 1:0.4 (space:substrate).

The apertures can be round holes, or rectangular slots, and can be positioned in zones or patterns to increase air flow through the absorbent food pad, and to provide greater tolerances for machine vibration during manufacturing to increase production speed and/or can be of any geometric configuration to better address the configuration of a food container.

The absorbent food pad has an absorbent body made of one or more layers of absorbent or superabsorbent material to absorb any condensation caused by cooling of the food product, and to reduce dripping of any active agents onto the fruit. The absorbent body has one or more active agents or generating system or other treatments, such as sulfur dioxide (SO₂) generating system, CO₂ generators, chlorine dioxide (ClO₂), oxygen (O₂) scavenger, desiccants, ethylene scavenger or antagonist, and the like, or any combinations thereof, and preferably sulfur dioxide (SO₂) generating system alone or in combination with one or more of the above active agents or generating systems, to minimize and/or prevent damage to a food product caused by botrytis and other microorganisms, and will provide good air flow, and assist to absorb excess moisture.

The absorbent food pad is placed in each separate crate and/or container in which the food product is packaged, so that each package receives its own source of SO₂ (or other active). The apertures permit the absorbent food pad to be placed on the bottom of each container and provide a discrete airflow passage through the absorbent food pad and through the entire container.

Some food products can be placed directly on the absorbent food pad of the present disclosure. Other food products, such as berries, can be packaged in a plastic clamshell, with the absorbent food pad positioned directly beneath the clamshell package inside the crate. Placing the absorbent food pad on the bottom also serves as cushioning that helps preserve the quality of the food.

The absorbent food pad can be used to enhance freshness and prolong the shelf life of fruits, vegetables, and other food products, including grapes, berries, and tomatoes.

A method of manufacturing of an absorbent food pad with apertures is provided.

### BRIEF DESCRIPTION OF THE DRAWINGS

FIG. 1 is a perspective view of an exemplary embodiment of an absorbent food pad of the present disclosure.

FIG. 2 is a cross-section of the exemplary embodiment of the absorbent food pad in FIG. 1 taken along axis A-A to include an aperture through the absorbent food pad.

FIG. 3 is a cross-section of another exemplary embodiment of the absorbent food pad in FIG. 1 taken along axis A-A, with an enlarged view to show the layers of the absorbent food pad.

FIG. 4 is a top view of the exemplary embodiment of the absorbent food pad in FIG. 1.

FIG. 5 is a top view of another exemplary embodiment of an absorbent food pad of the present disclosure.

FIG. 6A is a graph depicting a test of SO₂ concentrations measured over a period of time for a sample of sodium metabisulfite (Na₂S₂O₅) placed in an open environment.

FIG. 6B is a graph depicting the % Relative Humidity for each day of the test in FIG. 6A.

FIG. 7 is a graph depicting an “open system” test of SO₂ concentrations measured over a period of time of two experimental (PPI) Pads versus a commercial pad having a cell of two pockets that were taken apart and tested individually, where the two experimental pads are made of different materials and contain the same amounts of Na₂S₂O₅ as one or the other of the pockets of the cell in the commercial pad.

FIG. 8 is a graph depicting a “closed system” test of SO₂ concentrations measured over a period of time for a commercial pad having a cell of two pockets, comparing the amount of SO₂ gas generated by the full cell with the amounts of SO₂ gas generated by each of the two pockets.

FIG. 9 is a graph of a test of a grape pad in a box depicting SO₂ concentrations measured over a period of time inside a container for one-half of a commercial pad, and one-half of two experimental pads that are made of different materials, that each contain 3.5 g of Na₂S₂O₅.

### DETAILED DESCRIPTION OF THE DISCLOSURE

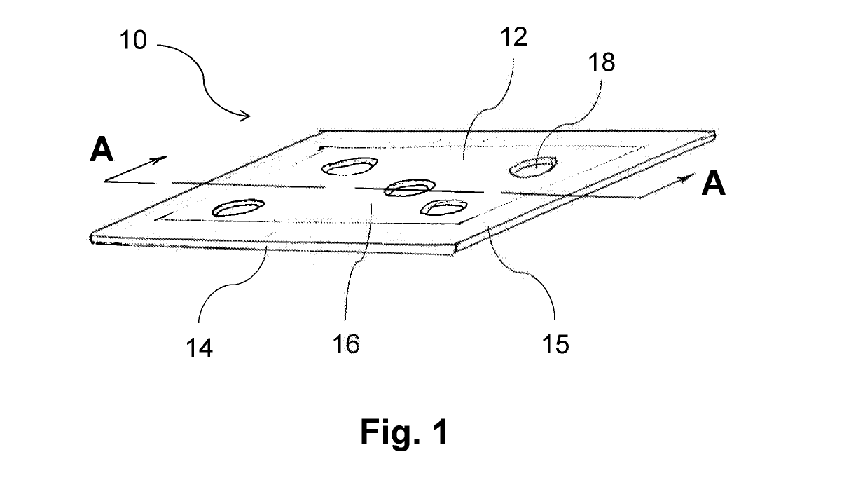

Referring to the drawings, and in particular, FIGS. 1 to 4, there is provided an exemplary embodiment of an absorbent food pad generally represented by reference number 10, with one or more apertures 18 that provide discrete airflow passages through absorbent food pad 10.

Absorbent food pad 10 has a top layer 12, and a bottom layer 14 opposite top layer 12. Between top layer 12 and bottom layer 14 is an absorbent body 16 made of one or more layers of an absorbent and/or superabsorbent material. Top layer 12 and bottom layer 14 directly contact each other and are sealed at edges 15 to seal absorbent food pad 10, and to enclose absorbent body 16. A laminate 19 can also be part of absorbent food pad 10, and is positioned between top layer 12 and bottom layer 14.

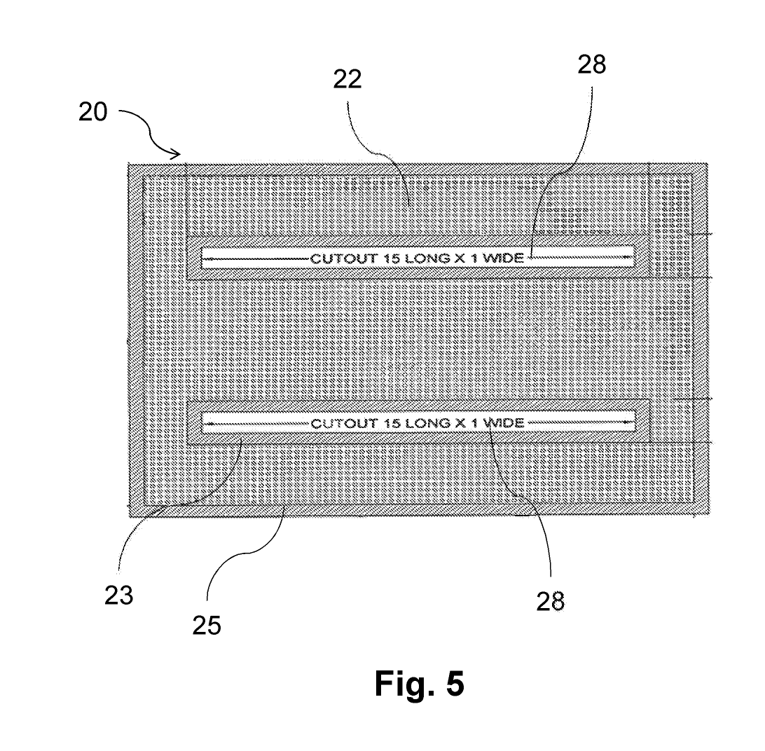

Absorbent food pad 10 has one or more apertures 18 forms a discrete airflow passage that permits airflow through absorbent food pad 10, and specifically through top layer 12, bottom layer 14, and absorbent body 16. In the exemplary embodiment in FIG. 1, absorbent food pad 10 has five (5) apertures 18, each of which is a round cut-out hole. In this embodiment, each round aperture 18 is about 2.5 inches in diameter. Aperture 18 can be any shape and, as shown in FIG. 5 for example, apertures 18 can be rectangular. A single absorbent food pad 10 can have multiple apertures 18 that are each a different shape and size.

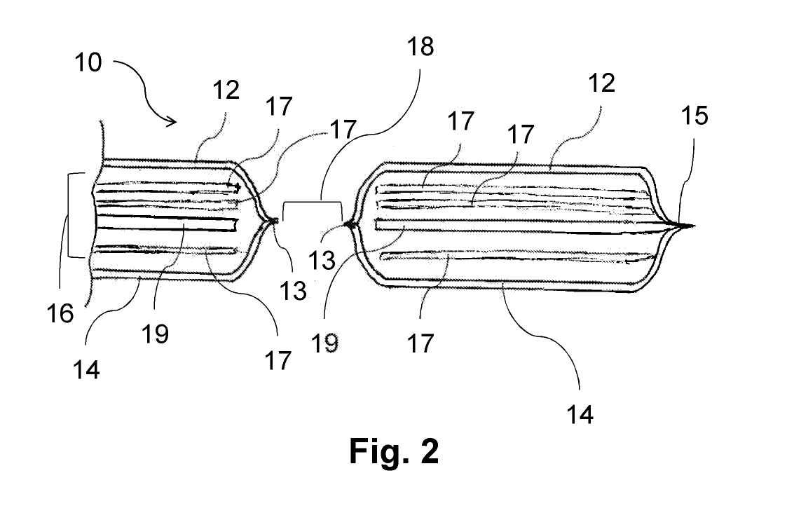

As shown in FIGS. 2-4, each aperture 18 is completely sealed around its periphery at aperture edge area 13. Thus, absorbent food pad 10 and its apertures 18 form an absorbent structure that is completely sealed. All absorbent material in absorbent body 16 is enclosed and sealed in absorbent food pad 10, and none of the absorbent material is exposed to the food product, even at apertures 18. The cut-out areas that forms aperture 18 provide discrete airflow passageways through absorbent food pad 10.

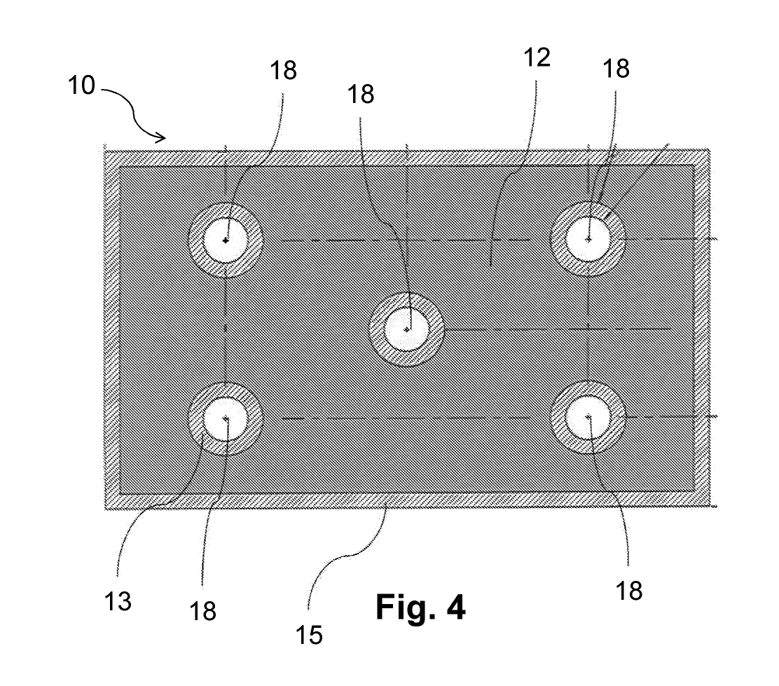

Apertures 18 (also called “holes” or “spaces” in this application without a change in meaning) are about 10% to about 68% of the geometric area of top layer 12 of absorbent food pad 10; i.e., the aggregate of the cut-out segments (i.e., apertures) removed from absorbent food pad 10 represent about 10% to about 68% of the total surface area of top layer 12 of absorbent food pad 10. More preferably, apertures 18 represent a range of about 15% to about 40%. In the exemplary embodiment in FIG. 4, apertures 18 are a total of about 19% of the total surface area of top layer 12 of absorbent food pad 10. Overall, apertures 18 must be sufficiently large to provide a discrete airflow passageway through absorbent food pad 10. However, if too much material is removed from absorbent food pad 10 (such as >80% of its total area), or if too much material is removed from a particular portion of absorbent food pad 10, the stability of absorbent food pad 10 will be decreased and can cause pad failures.

Apertures 18 can also be thought of as representing the removal of material from absorbent food pad 10 to form a space therethrough, so that a ratio of space-to-substrate is from about 1:9 to about 1:0.4 in absorbent food pad 10. As used in this application, “substrate” means the entirety of absorbent food pad 10, including top layer 12, bottom layer 14, and absorbent body 16. In the exemplary embodiment illustrated in FIG. 4, the ratio of space-to-substrate is about 1:4, which corresponds to about 20% of the surface area of top layer 12.

Apertures 18 can be positioned in absorbent food pad 10 in zones or in patterns to increase air flow through apertures 18 of absorbent food pad 10. Apertures 18 have to be of sufficient size to form a discrete airflow passage that does not impede the flow of cold air that is forced through the containers (crates) during transport and storage of fruits, such as grapes or berries. As used herein, apertures 18 do not include perforations or microperforations in absorbent pad layers. Instead, apertures 18 must be sufficiently large in size to permit forced (cold) air to pass unimpeded (or substantially unimpeded) through absorbent food pad 10, and through the food product. Perforations or microperforations, by contrast, would limit or even prevent airflow through an absorbent pad, and are intended to perform a different function than apertures 18, including allowing active gases to slowly permeate out of a pad into a food package.

Apertures 18 can be positioned a certain distance away from edges 15 of absorbent food pad 10, to provide more tolerances to account for machine vibration during manufacturing. Positioning apertures 18 at least a certain distance from the edge of absorbent food pad 10 can also speed production time.

Top layer 12 is a film that is polyethylene, polypropylene, polyester, or any combinations thereof. In an exemplary embodiment, top layer 12 is a blown polyethylene film. The blown polyethylene film can have a thickness of about 0.65 mil. In another embodiment, top layer 12 is any nonwoven material. In yet another embodiment, top layer 12 is made of coffee filter tissue (CFT).

Bottom layer 14 is a nonwoven material that is a polyolefin, polyester, or polyamide. Examples of nonwovens films for bottom layer 14 include, but are not limited to, polyethylene, polypropylene, polyester, or any combinations thereof. In a preferred exemplary embodiment, bottom layer 14 is made of spunbonded polypropylene. In another preferred embodiment, bottom layer 14 is made of a perforated polyethylene or perforated polypropylene. Bottom layer 14 can also be a hydrophilic nonwoven material, or treated with a surfactant or other hydrophilic material, to permit liquid uptake into tissue layers 17 and laminate 19. Alternatively, bottom layer 14 can be made of coffee filter tissue (CFT). The CFT can be made of a 16.5-pound white crepe paper that is about 99.5% softwood pulp, where “softwood pulp” means a pure virgin wood pulp that has never been processed. The softwood pulp can be bleached or unbleached. CFT can also contain about 0.5% of a wet-strength resin to give strength to the cellulosic fibers of the CFT when wet. An example of a wet-strength resin includes, but is not limited to, polyamide-epichlorohydrin (PAE) resin.

Absorbent body 16 is made of one or more layers of an absorbent material or a superabsorbent material. Absorbent body 16 absorbs liquids exuded from a food product that is placed on absorbent food pad 10, and/or condensation in the container that forms while cooling the food product during storage or transport. Absorbent body 16 is preferably made of an absorbent material that is one or more layers of tissue 17. Each tissue layer 17 is made of a sheet of cellulose tissue, and can itself be formed of one or more individual tissues that are joined together to form the tissue layer. The number of tissue layers 17, as well their arrangement in the pad architecture of absorbent food pad 10, can be varied to regulate the absorption for the absorbent food pad, as well as to regulate activation of any active agents therein. Besides tissue, the absorbent material can also be fluff pulp, cellulosic material, binding fiber, airlaid, nonwoven, woven, polymer, absorbent gels, compressed composite with short or microfiber materials, thermoplastic polymer fibers, cellulose powders, or any combinations thereof. Examples of a superabsorbent material includes, but are not limited to, polyacrylates or carboxymethyl starch (CMS), superabsorbent polymer (SAP), compressed SAP, composite of SAP granules adhered with binder or plasticizer, airlaid with SAP, or a starch-based superabsorbent material, such as BioSAP™ (Archer-Daniels Midland, Decatur, Ill.), which is biodegradable and compostable. The nonwoven material may be spunbonded polypropylene or perforated plastic films.

The absorbency of the absorbent material and/or superabsorbent material and/or laminate 19 in absorbent body 16 is typically from about 120 grams to about 200 grams for an absorbent food pad 10 having outer dimensions of about 12″ by about 20″, where “absorbency” means the weight of liquid that can be absorbed by absorbent food pad 10. More preferably, the total absorbency of absorbent food pad 10 is from about 145 grams to about 175 grams, and still more preferably, the total absorbency of absorbent food pad 10 is about 160 grams.

As described above, absorbent body 16 is preferably slightly smaller than the overall outer dimensions of absorbent pad 10, so that top layer 12 and bottom layer 14 can be more easily sealed around edges 15. In an exemplary embodiment, absorbent body 16 is about nineteen inches (19″) (48.3 cm) in length by about eleven inches (11″) (27.9 cm) in width, which can be used in absorbent food pad 10 having overall outer dimensions of twenty inches (20″) (50.8 cm) in length by about twelve inches (12″) (30.5 cm) in width, thereby leaving about 0.5 inches (0.5″) (1.3 cm) around all four edges 15 of absorbent food pad 10 for sealing.

Absorbent food pad 10 preferably includes a laminate 19 positioned between top layer 12 and bottom layer 14. When present, laminate 19 is preferably a part of absorbent body 16, along with tissue layers 17 and/or other absorbent material. Alternatively, laminate 19 can be the entirety of absorbent body 16. Laminate 19 is made of one or more plies of a cellulosic material, an adhesive (such as glue) or binder, and preferably includes an active agent. In an exemplary embodiment of absorbent food pad 10 of the present disclosure, laminate 19 is a mixture of cellulosic material and an active agent, preferably SO₂ generation system (active agent) that contains sodium metabisulfite (Na₂S₂O₅) that, when activated with water, condensation, or by contact with liquid purge from the food product, reacts to generate SO₂.

Laminate 19 offers several advantages for absorbent food pad 10. First, laminate 19 can incorporate large amounts of an active agent in a relatively thin structure, while avoiding the disadvantages of having large amounts of dry, loose chemicals that can cause the absorbent food pad to “bulge” or have active agents that collect disproportionately in one portion of absorbent food pad 10 when the pad is picked up by one edge. Second, because an active agent can be uniformly distributed in laminate 19, selecting a prescribed length and number of plies of laminate 19 permits the total amount of active agent to be determined with certainty. The active agent of laminate 19 can include an active agent or generating system, such as a sulfur dioxide (SO₂) generating system, CO₂ generators, chlorine dioxide (ClO₂), oxygen (O₂) scavenger, desiccants, ethylene scavenger or antagonist, and the like, or any combinations thereof, to minimize and/or prevent damage to a food product caused by botrytis and other microorganisms, and will provide good air flow, and assist to absorb excess moisture.

An exemplary embodiment of laminate 19 is a cellulosic material and an SO₂ generation system (e.g., Na₂S₂O₅) that is uniformly distributed therein to form one or more plies of laminate 19. Absorbent food pad 10 can have about 1 gram to about 20 grams of an SO₂ generation system, which is preferably Na₂S₂O₅ that is uniformly distributed in the plies of laminate 19. More preferably, absorbent food pad 10 has about 5 grams to about 9 grams of an active system, such as an SO₂ generation system. Still more preferably, absorbent food pad 10 contains about 7 grams of an active system, such as an SO₂ generation system. The specific amounts of the active agent/active system and its position in relation to the absorbent material can be selected depending on the size of absorbent food pad 10 and the type and quantity of fruit that is being preserved. An advantage of incorporating large amounts of active agent in laminate 19 is the large reservoir of active agent that is available for “extended release” of the active agent over time. Laminate 19 can also have therein one or more active systems or a combination of two different active systems. These active systems include, but are not limited to, desiccants, oxygen scavengers, carbon dioxide generators, antimicrobials, chlorine dioxide generators.

Absorbent food pad 10 can have active agent/active system (for example, an SO₂ generation system in the absorbent food pad as Na₂S₂O₅ that will react with water or moisture to form SO₂) that is present in absorbent food pad 10 in an amount that is between 0.01 grams per square inch (gsi) to about 0.10 gsi. More preferably, the active agent or active system is present in absorbent food pad 10 in an amount from about 0.02 to about 0.45 gsi, and still more preferably, the active agent is present in absorbent food pad 10 in an amount of about 0.038 gsi.

In a preferred embodiment, absorbent body 16 has an active agent that is a sulfur dioxide (SO₂) generating system to prevent botrytis and other damage to a food product caused by microorganisms. However, as mentioned above, other active agents, such as CO₂ generators, chlorine dioxide (ClO₂), oxygen (O₂) scavenger, desiccants, oxygen scavengers, ethylene scavenger or antagonist, and the like, or any combinations thereof, can be used with, or instead of, the SO₂ generating system. An exemplary embodiment of a CO₂ generation system is an acid and a base, such as citric acid and sodium bicarbonate, respectively, that react with each other (when activated by water or other liquid) to generate CO₂ gas. The acid component of the CO₂ generation system can be a food-safe organic acid or an inorganic acid. The ratio and amounts of acid and base, as well as their physical placement in the pad architecture, can be varied to control the timing and amount of CO₂ released. In one exemplary embodiment, citric acid and sodium bicarbonate are present in absorbent body 16 in a ratio of about 4:6, which can be activated by moisture and/or other food exudates to generate CO₂ gas. Citric acid provides an additional benefit by interacting with the sodium ion of sodium bicarbonate to create a citric acid/sodium citrate buffer system that helps maintain a pH that is food-compatible. Other acids can be selected for a CO₂ generation system, with amounts and ratios adjusted in accordance with the pKₐ of the acid. Another example of an active agent in absorbent body 16 is an antimicrobial agent. Examples of an ethylene inhibitor or ethylene competitor agents include, but are not limited to, 1-methylcyclopropene, (also called “MCP” or “1-MCP”), or its salts or chemical derivatives. The one or more ethylene competitor agents can be selected to bind either reversibly or irreversibly to the ethylene receptors. Examples of an oxygen scavenging system include, but are not limited to, an enzyme such as glucose oxidase, catalase, oxidoreductase, invertase, amylase, maltase, dehydrogenase, hexose oxidase, oxygenase, peroxidase, cellulase, or any combinations thereof. Other examples of an oxygen scavenging system include an oxidizable metal, including but not limited to, iron, zinc, copper, aluminum, tin, or any combinations thereof. Examples of an antimicrobial agent include organic acids (such as citric acid, sorbic acid, lactic acid, or any combinations thereof), quaternary ammonium compound, inorganic acid, or any combinations thereof.

Each active agent/active system can be positioned in a pocket in absorbent food pad 10 that is formed by: any two tissue layers 17; any tissue layer 17 and laminate 19; topmost tissue layer 17 and top layer 12; and/or bottommost tissue layer 17 and bottom layer 14. Alternatively, an active agent can be incorporated in one or more plies of laminate 19.

The cold air that is forced through the food product (e.g., fruits, such as grapes and berries) is often recycled to avoid having to re-cool the air, and so the storage or transport room becomes a closed system in which air is not being vented out into the ambient environment. In a closed environment, SO₂ can rapidly reach concentrations in the room that can further enhance shelf life, appearance, and freshness of the food product, and also prevent botrytis and other infections that can cause deterioration of the food product.

In addition, absorbent food pads 10 provide effective, individualized treatment for each of the crates of the food product, without requiring large-scale generation of SO₂ that may be produced by some conventional methods that simply place a bucket of a SO₂ precursor in an enclosed room and generate SO₂ to fill the room in order to achieve active treatment concentrations to protect the food product inside the crates. The present method of using absorbent food pads 10 reduces the likelihood of SO₂ toxicity or allergies for workers caused by exposure to very high concentrations of SO₂ produced in an enclosed room by some conventional methods.

Optionally, to obtain a higher concentration of the active gas in the crates, a large barrier material, such as plastic, can be placed over the crates of the food product by creating, in effect, a miniature closed system. However, absorbent food pads 10 are generally so effective for treatment for the prevention of botrytis and other infections, since the absorbent food pad is placed in each individual crate, that the use of a barrier material is not necessary to enhance freshness and prolong shelf life of food products.

As noted above, absorbent food pad 10 is sealed around its periphery at edges 15. In an exemplary embodiment, the sealed portion is about a half-inch (0.5″) (1.3 cm) around each edge 15. However, the amount of edge 15 that is sealed can vary in size to be more or less than 0.5″.

Absorbent food pad 10 can be made with outer dimensions and of a shape that accommodates the shapes of the containers or crates used for storage or shipment of the food product. In an exemplary embodiment, absorbent food pad 10 has outer dimensions that are about twenty inches (20″) (50.8 cm) in length by about twelve inches (12″) (30.5 cm) in width, and is rectangular in shape. However, the size and shape can be adjusted to fit the footprint of the container or crate.

Absorbent food pad 10 preferably covers the entire footprint of the crate (container) in which the food product is stored and transported to provide effective treatment of the food product over time, where “footprint” means the surface area of the bottom of the crate. However, absorbent food pad 10 can cover less than the entire footprint of the crate in which the food product is transported and stored, and still provide sufficient concentrations of the active agent to effectively treat of the food product to achieve the desired results. Absorbent food pad 10 can cover about 60% to about 100% of the footprint of the container (crate) and provide effective treatment of the food product. In fact, an absorbent food pad 10 that covers at least 50% of the footprint of the crate can still provide a relatively effective treatment of the food product. Conversely, absorbent food pad 10 can be larger than the footprint of the crate (i.e., greater than 100% of the footprint of the crate), but the portion of the absorbent food pad that exceeds the size of the footprint is unnecessary and a waste of material.

The outer dimensions of absorbent food pad 10 can be customized to fit the particular footprint of the container/crate used for transport and storage of the food product. For example, grapes are often stored and transported in crates that are relatively small, to reduce the risk of injuring the grapes, and so absorbent food pad 10 that is 12″ by 20″ in its outer dimensions covers the entire footprint of the grape crate. Berries, such as strawberries, raspberries and cranberries, are often transported and stored in plastic clamshell containers that are each about 4″ wide by about 7″ long by about 5″ deep, or about 4″ by about 4″ by about 4″ (e.g., a quart-sized clamshell container). If several clamshell packages of berries are packaged side-by-side, and/or stacked 2 or 3 or more, up to about 5, clamshell packages high (since the clamshell packaging protects the berries from injury), a single absorbent food pad 10 can be used that covers all or most of the footprint of the container in which multiple clamshell packages of berries are placed.

To manufacture absorbent food pad 10, apertures 18 are preferably punched in absorbent body 16. In the exemplary embodiment shown in FIGS. 1-3 above, this is done with a 2.5″ diameter hole punch. An adhesive, such as hot melt glue, is applied to the polyethylene top layer 12 as it runs through the production machine. Top layer 12, bottom layer 14 (both still whole at this point), and absorbent body 16 (with apertures punched through) are arranged as a sandwich, and pressed together. Then apertures 18 are punched through top layer 12 and bottom layer 14, but at a smaller size than in absorbent body 16 (i.e., less than 2.5″), and using a different die. In this way, the final absorbent food pad is completely sealed around edges 15 and completely sealed around the periphery of each aperture 18 at sealed aperture edge 13.

Referring to the exemplary embodiment of absorbent food pad 10 shown in FIG. 2, top layer 12 is polyethylene film, and bottom layer 14 is spunbond polypropylene nonwoven. Absorbent body 16 has two tissue layers 17, one of which is adjacent to top layer 12, and another tissue layer 17 that is adjacent to laminate 19. Laminate 19 is a cellulosic material, such as crepe tissue, and contains an SO₂ generation system (e.g., Na₂S₂O₅), and glue to hold the laminate together. Another tissue layer 17 is positioned below laminate 19 and adjacent to bottom layer 14.

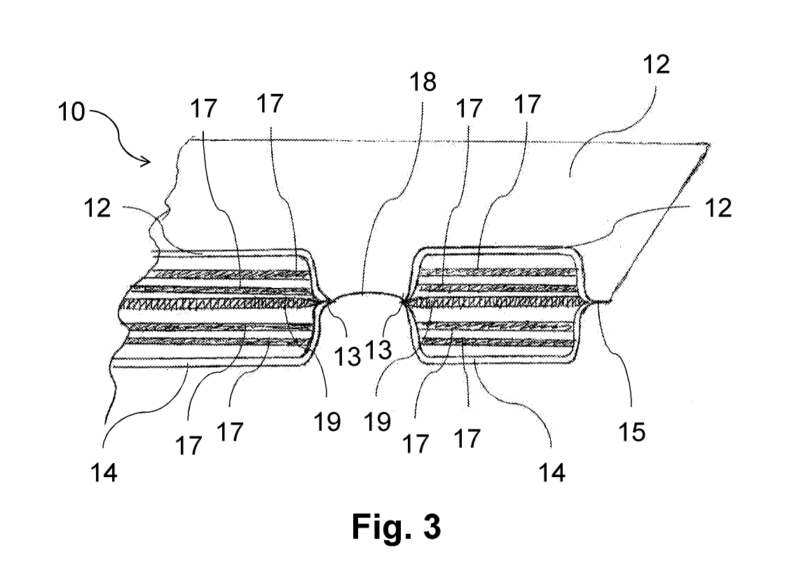

FIG. 3 shows a cross-section of another exemplary embodiment of absorbent food pad 10, which is identical to FIG. 2, except that there are two tissue layers 17 between laminate 19 and bottom layer 14.

Absorbent food pad 10 is placed in each separate crate and/or container in which the food product is packaged, so that each package receives its own source of SO₂ (or other active). Apertures 18 permit absorbent food pad 10 to be placed on the bottom of each container and still provide a passageway for unimpeded airflow through the entire container.

Even with one or more apertures 18, absorbent food pads 10 of the present disclosure do not “dry out.” Also, absorbent food pads 10 do not have to be “pre-wetted” with water or other liquid before use.

In some instances, the food product, such as grapes, can be placed directly on absorbent food pad 10. Other types of food products, such as berries, are usually packaged inside a plastic clamshell, and absorbent food pad 10 is positioned directly beneath the clamshell package inside of the crate or other container.

FIG. 5 is another exemplary embodiment of an absorbent food pad with apertures, generally represented by reference number 20. Absorbent food pad 20 has a top layer 22, a bottom layer (not shown), and an absorbent body (not shown) between the top layer and the bottom layer, where the absorbent body is made of one or more layers of an absorbent or superabsorbent material. The bottom layer and absorbent body can be identical to those of FIGS. 1-4. Absorbent food pad 20 is sealed around edges 25 to enclose the absorbent body. Absorbent food pad 20 has apertures 28 that pass through top layer 22, the bottom layer, and the absorbent body. In this embodiment, absorbent food pad 20 has two apertures 28 that are rectangular cutouts. Apertures 28 are each sealed around its periphery at aperture edge area 23, so that aperture 28, as well as the entire absorbent food pad 20, is completely sealed. In this embodiment, apertures 28 are each about 15 inches (38.1 cm) in length and about 1 inch (2.5 cm) in width.

As used in this application, the “pad architecture” of absorbent food pad 10 and/or 20 means the structure and order of individual tissue layers 17, laminate 19, the top and bottom layers, or any active agents therein. “Regulation” means controlling the speed, location, and amount of liquid absorption, as well as controlling activation speed and duration of release of active agents. Thus, varying the pad architecture can be used to regulate uptake of liquids exuded by a food product on absorbent food pad 10, and regulate activation, rate of release, and duration of the active agent. A pad architecture that physically separates the individual chemical components of an active agent with tissue layers can be selected to delay activation and/or provide an “extended release” of the active agent contained in absorbent food pad 10. For example, positioning a larger number of tissue layers 17 above and/or below laminate 19 can delay activation and extend release of an active agent (e.g., a SO₂ generation system) in laminate 19. In an exemplary embodiment, as shown in FIG. 3, positioning two or more tissue layers 17 above and two or more tissue layers 17 below laminate 19 can delay activation, and serve as a reservoir for extended release of the SO₂ generation system in laminate 19.

As used in this application, “scaling,” means selecting the proper amounts of active agent in relation to the amount of absorbent material and the type of food product being packaged. Scaling is critical to the performance of absorbent pads 10, 20. Some food products produce very little moisture or liquid exudates (also called “purge” in this application) that would be available to activate the active agent, while other food products produce a large amount of moisture or liquid exudates. For example, if absorbent food pad 10, 20 has too many tissue layers 17 relative to the amount of liquid purge, there may be insufficient liquid to dissolve the active agent(s) for their activation. Conversely, too few tissue layers 17, combined with a large volume of liquid purge, can dilute or even “drown” the active agent, thereby impairing its effectiveness. In addition, the number, size, and placement of apertures 18 in absorbent food pad 10, 20 can be considered for scaling.

The amount of active agent in the pad architecture of absorbent food pad 10, 20 of the present disclosure for a given container size can also be tailored depending on several factors, including, but not limited to: the total volume of the container; the amount of the food product in the individual food package (i.e., how much volume the food product occupies); how much of the active agent, such as SO₂, is expected to be lost (e.g., by dissolving of the active agent in the moisture on the surface of the food product, and/or by leaking of the active agent out of the container); or other physical factors, such as temperature and pressure. Likewise, as noted above, the pad architecture can be tailored to regulate the rate of release of the active agent. For example, using a pad architecture where portions of the active agent are physically separated can provide a sustained release of an active agent (such as SO₂) to provide maximum capacity of the active agent in the food package.

Absorbent food pads 10 and 20 disclosed herein can be used in food packages to extend shelf life and food freshness, and to enhance the appearance of packaged foods.

Examples of food products that can be packaged with absorbent food pads 10 and 20 disclosed herein include, but are not limited to, grapes, berries, figs, or tomatoes. Smaller food pieces have a large surface area that can absorb gases in a food package, and so would benefit from absorbent food pad 10 or 20 disclosed herein, which can replenish an active agent, such as SO₂, over an extended time of storage and transport.

The amount of SO₂ generated by the absorbent food pad 10, 20 can be controlled based on the amount of its chemical precursor(s), such as Na₂S₂O₅, and access of the chemical precursor to moisture in the air, and/or contact with liquid exuded from the food product and absorbed by absorbent body 16.

### Experimental

### Tests Performed

The amounts and concentrations of SO₂ that were generated under different conditions were tested as described below.

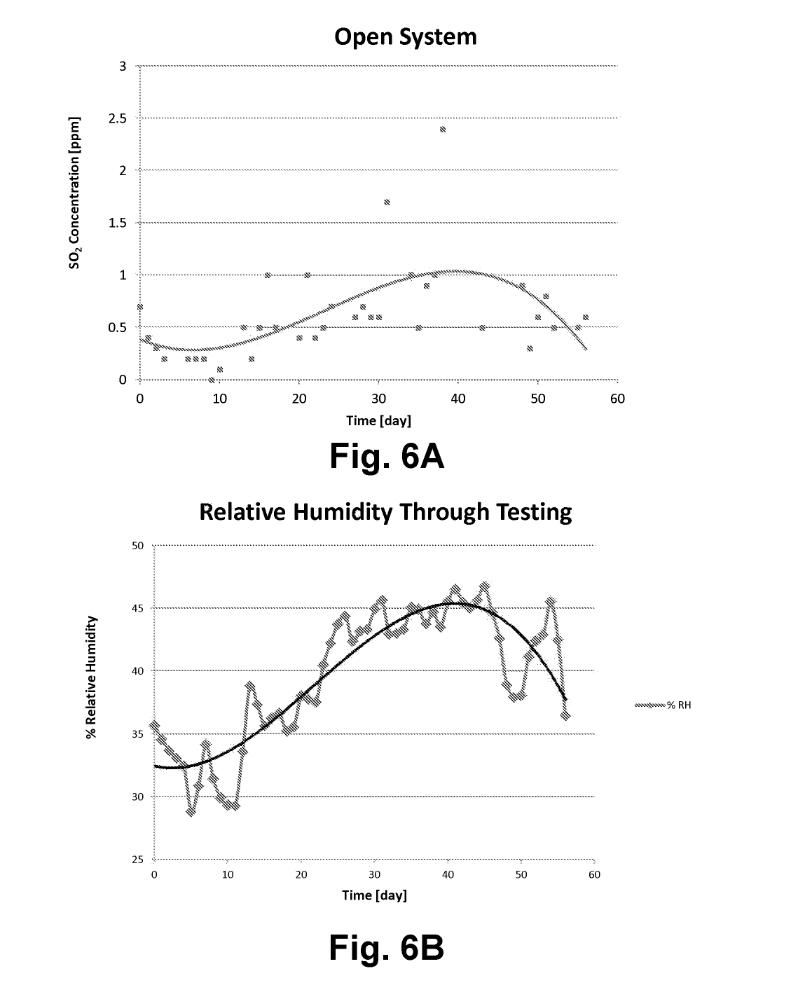

FIG. 6A and FIG. 6B show the results of a test that was performed to establish how Na₂S₂O₅ reacts with the environment, and the effect of changes in relative humidity.

0.1 g of Na₂S₂O₅ on sampling “boats” were placed on top of a counter; i.e., in an “open” environment. The concentration of SO₂ gas (in parts per million, ppm) in the air at about 2.5 cm (about 1″) above the Na₂S₂O₅ was measured daily for more than 50 days of testing. The relative humidity was also measured for each day of testing.

FIG. 6A shows a graph of SO₂ concentration (ppm) and the number of days of testing. The data indicate that 0.1 grams of Na₂S₂O₅ in an open environment generated an average of 0.5 ppm of SO₂ for up to 50 days.

FIG. 6B shows the relative humidity for each day during the trial, shown as % Relative Humidity and days of testing. The data indicate an apparent correlation between the relative humidity and the amount of SO₂ gas generated. This is in agreement with the known chemistry of Na₂S₂O₅.

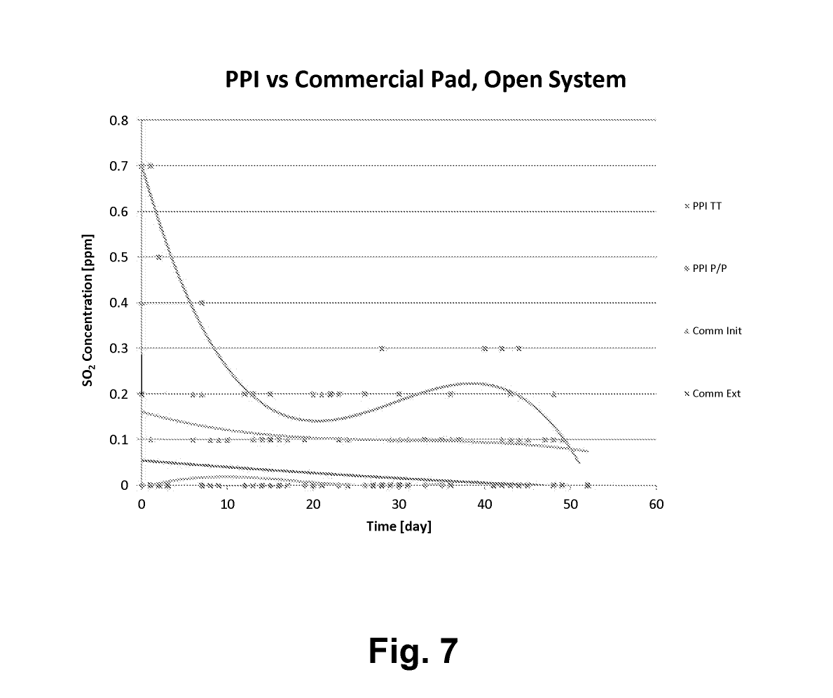

FIG. 7 shows the results of an “open system” test, in which the SO₂ gas generation of two absorbent food pads (labeled as “PPI-TT” and “PPI-P/P,” respectively) having different structures and different amounts of Na₂S₂O₅, were compared against a commercial pad (labeled as “Ch Init”) having two pockets that generate SO₂ gas. The “open system” test means that the SO₂ gas generated by the absorbent food pads was vented.

The “PPI-TT” pad in FIG. 7 has a top layer and a bottom layer that are both made of Coffee Filter Tissue (CFT), and the pad contained 0.05 of Na₂S₂O₅. The “PPI-P/P” pad has a top layer and a bottom layer that are both made of polyethylene, and the pad contained 0.25 g of Na₂S₂O₅.

The commercial pad in FIG. 7 has two pockets, the first pocket containing 0.05 g of Na₂S₂O₅ to provide an “initial burst” of SO₂ and the second pocket containing 0.25 g of Na₂S₂O₅ to provide an “extended release” of SO₂.

The pads were placed in an open environment to mimic the actual conditions of use. SO₂ concentrations were measured for more than 50 days, and the SO₂ concentrations over the number of days of testing.

FIG. 7 shows that both the PPI P/P pad and the extended release pocket of the commercial pad released very low levels of SO₂. The initial burst pocket and the PPI-TT pad released an average of 0.1 ppm of SO₂ into the surrounding atmosphere. It was observed that the PPI-TT pad released a burst of gas at the beginning of the cycle and then, after 15 days, reached a similar equilibrium point as the initial release portion of the commercial pad at about 0.2 ppm of SO₂.

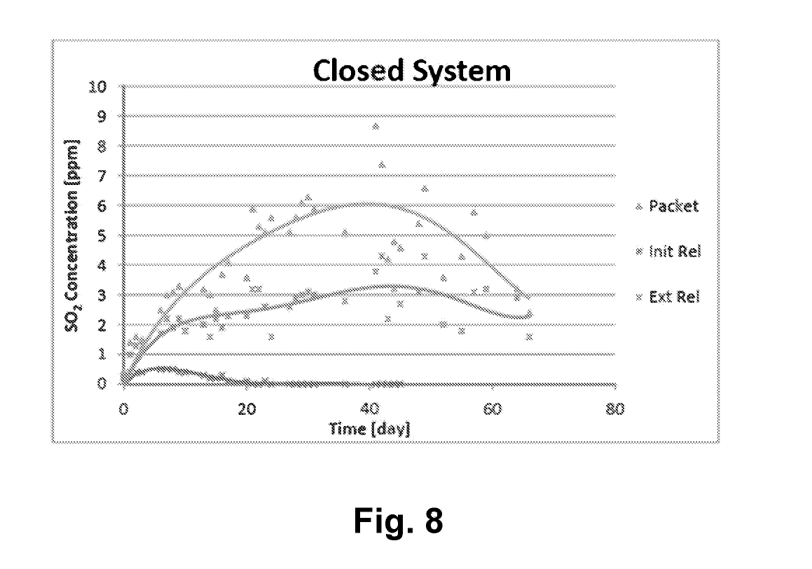

FIG. 8 shows the results of a “closed system” test. In this test, a commercial pad was taken apart and the amounts of SO₂ generated by the individual pockets (called the “initial burst” pocket and “extended release” pocket, respectively) were measured against the SO₂ generated by a full cell (i.e., both pockets together). The “initial burst” pocket contained about 0.05 grams of Na₂S₂O₅ and the “extended release” pocket contained about 0.25 g of Na₂S₂O₅. The full cell contained about 0.3 g of Na₂S₂O₅, which is the sum of the two individual pockets. The “full cell” refers to only one cell of the full pad; the full pad would contain approximately 7 g of Na₂S₂O₅. Each of the three samples was placed in a sealed tray to directly measure the amount of SO₂ generated. This allowed the amount of SO₂ generated to be measured without losses due to environmental influences (for instance, air movement).

FIG. 8 shows the results of SO₂ concentration (ppm) measured over more than 60 days. The data indicate that the total amount of SO₂ gas generated roughly correlates to the amounts of SO₂ generated by each of the individual components. No initial burst of SO₂ was observed.

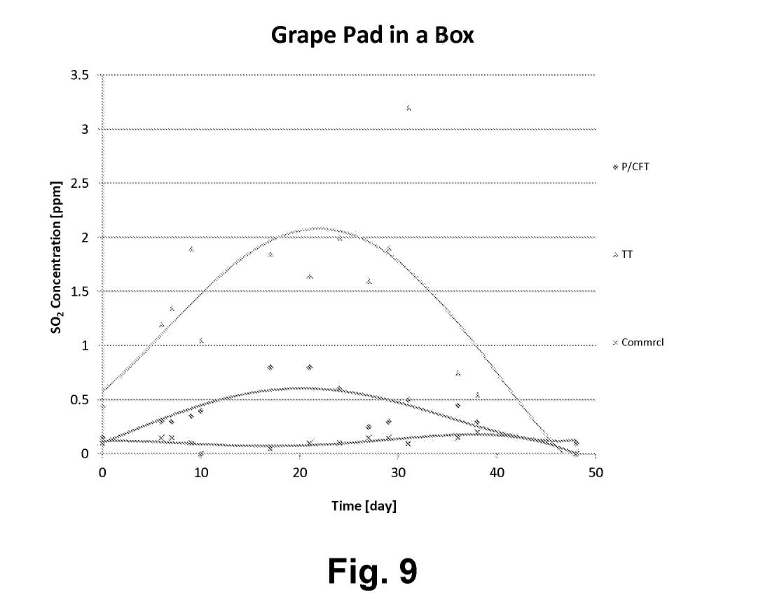

FIG. 9 shows the results of a “Grape Pad in a Box” test. In this test, three different pads were placed inside a container having about the same dimensions as a typical grape case. The containers had a loose flap that was used to simulate the relatively closed environment of the grape boxes, and that allowed gas measurements to be taken. The pads were labeled: “P/CFT” (i.e., polyethylene top layer, Coffee Filter Tissue bottom layer); “TT” (CFT top layer and CFT bottom layer), and “Chi” (a commercial pad having two pockets, described above).

One half-pad of each type containing 3.5 g of Na₂S₂O₅ was placed inside the container, to simulate actual conditions for storage and transport of grapes. Measurements were taken by placing the SO₂ probe in the middle of the container.

FIG. 9 shows the results of this comparison of SO₂ concentration (ppm) over more than 40 days of measurements. The results show that the P/CFT pad is able to produce about the same amount of SO₂ gas (with a slightly higher yield) as the commercial pad. The CFT/CFT pad releases larger amounts of SO₂ gas than either of the other two pads tested.

Based on the several tests above, the results indicate that Na₂S₂O₅ has the capability to generate a continuous stream of SO₂ for more than 50 days; in fact, several tests showed SO₂ gas generation continues past the 60-day mark.

The gas generation chart shows a direct correlation of SO₂ generation and Relative Humidity in the atmosphere.

The total amount of SO₂ gas generated by a two-pocket commercial pad appears to be the sum of SO₂ gas generated by each of the pockets. The commercial pad does not appear to provide an initial burst of SO₂.

The pad made with a CFT top layer and CFT bottom layer (TT) shows an initial higher level of SO₂ generated, and then levels off at about 0.2 ppm of SO₂. This is somewhat higher than the levels generated by the commercial pad (about 0.1 ppm of SO₂). The pad having a polyethylene top layer and polyethylene bottom layer showed a lower total amount of SO₂ gas generated across the time period evaluated.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances that fall within the scope hereof.

We claim:

1. An absorbent food pad for use with fruits and/or vegetables, comprising
an absorbent body having one or more discrete airflow passages through the absorbent body, the absorbent body having a top surface that contacts the fruits and or vegetables and a bottom surface, the absorbent body being made of one or more layers of absorbent or superabsorbent material to absorb any condensation caused by cooling of the fruits and/or vegetables, the absorbent body being sealed around its edges to enclose the absorbent body,
wherein the one or more discrete airflow passages pass through the top surface, the bottom surface, and the absorbent body so that the absorbent food pad enhances freshness and prolongs the shelf life of the fruits and/or vegetables.

2. The absorbent food pad of claim 1, wherein the one or more discrete airflow passages represent about 10% to about 68% of the geometric area of the top surface of the substrate.

3. The absorbent food pad of claim 1, wherein the absorbent body has a ratio of space-to-substrate of, from about 1:9 to about 1:0.4.

4. The absorbent food pad of claim 1, wherein the one or more discrete airflow passages can be of a configuration selected from the group consisting of round and rectangular.

5. The absorbent food pad of claim 2, wherein the one or more discrete airflow passages can be positioned in zones or patterns to increase air flow through the absorbent food pad.

6. The absorbent food pad of claim 5, wherein the one or more discrete airflow passages provide greater tolerances for machine vibration during manufacturing of the absorbent food pad.

7. The absorbent food pad of claim 1, wherein the absorbent body has one or more active agents therein achieve at least one attribute selected from the group consisting of: minimize or prevent damage, preserve freshness, extend shelf life, and any combination thereof, to the fruits and/or vegetables.

8. The absorbent food pad of claim 7, wherein the one or more active agents is a sulfur dioxide (SO₂) generating system.

9. The absorbent food pad of claim 1, wherein the absorbent body has five apertures.

10. The absorbent food pad of claim 9, wherein each of five apertures is a round cut-out hole.

11. The absorbent food pad of claim 10, wherein each round aperture is about 2.5 inches in diameter.

12. The absorbent food pad of claim 1, wherein the one or more discrete airflow passages has a different shape and size.

13. The absorbent food pad of claim 1, wherein the one or more discrete airflow passages is completely sealed around its periphery to form an edge area.

14. The absorbent food pad of claim 1, wherein the one or more discrete airflow passages and the absorbent body are completely sealed and completely sealed form each other.

15. The absorbent food pad of claim 1, wherein each of the one or more discrete airflow passages is about 15 inches in length and about 1 inch in width.

16. The absorbent food pad of claim 1, wherein the absorbent food pad has outer dimensions of about twenty inches in length by about twelve inches in width.

17. The absorbent food pad of claim 1, wherein the fruits and/or vegetables are placed directly on the absorbent food pad.

18. The absorbent food pad of claim 1, wherein the fruits are grapes and/or berries.

19. The absorbent food pad of claim 1, wherein the vegetables are tomatoes.

20. An absorbent food pad for use with fruits and/or vegetables, comprising
an absorbent body having one or more discrete airflow passages through the absorbent body and an active system that enhances freshness, the absorbent body having a top surface and a bottom surface, the absorbent body being made of one or more layers of absorbent or superabsorbent material to absorb condensation, the absorbent body being sealed around its edges to enclose the absorbent body,
wherein the one or more discrete airflow passages pass through the top surface, the bottom surface, and the absorbent body, and wherein the one or more discrete airflow passages is completely sealed around its periphery to form an edge area so that the one or more layers of absorbent or superabsorbent material is discrete from the one or more discrete airflow passages.
